(19) United States
(12) Patent Application Publication
(10) Pub. No.: US 2022/0198405 A1
(43) Pub. Date: Jun. 23, 2022

(54) APPARATUS, SYSTEM AND METHOD FOR BUILDING SYSTEM DIAGNOSTICS

(71) Applicants: Walt L. Pfeifer, Manorville, NY (US); Timothy Dorsa, Manorville, NY (US)

(72) Inventors: Walt L. Pfeifer, Manorville, NY (US); Timothy Dorsa, Manorville, NY (US)

(21) Appl. No.: 17/557,310

(22) Filed: Dec. 21, 2021

Related U.S. Application Data
(60) Provisional application No. 63/129,189, filed on Dec. 22, 2020.

(51) Int. Cl. G06Q 10/00

(52) U.S. Cl. CPC G06Q 10/20

(57) ABSTRACT

A system, method and apparatus is described for a diagnostics platform that allows for building systems diagnostics based on any API protocol or relevant of the protocol through system data allowing for building managers to diagnose and control individualized systems within a building structure.

### CROSS-REFERENCE TO RELATED APPLICATIONS

This application claims priority to and is a non-provisional of U.S. Patent Application 63/129,189 (filed Dec. 22, 2020), the entirety of which is incorporated herein by reference.

### BACKGROUND OF THE INVENTION

### Field of the Invention

The present invention relates generally to an apparatus, system and method for managing, diagnosing and servicing building systems. More specifically the present invention relates to a software application that communicates with building system networks including lighting controls, shades, HVAC, and communications technologies.

The present invention requires a building with a network, network architecture, wireless type technology, and centralizing that back over some level of an IP network architecture to allow for the processor or server to see it.

### General Background

Modern building, commercial and residential typically include multiple networked systems built into the architecture. Such systems include security systems, lighting systems HVAC systems, monitoring systems, elevator systems, shade and external light control systems, fire suppression systems, water systems and numerous other systems.

Each of these systems typically includes individual and separate control and monitoring applications. In most commercial building a management company can monitor each system from a central control room where each of the respective system network control patches are maintained. Residential systems are similar in that a homeowner can maintain and monitor most home systems from a mobile device application or central keypad type devices.

Modern commercial control rooms include individual monitoring systems for the various multiple building systems inherit therein. Each of these systems typically comprises its own application, their own graphical user interface (GUI) and their own application protocol interface (API) designed specifically to order to manage its own system. As a result, building managers, and even home owners, are required to navigate multiple separate interfaces and systems for each respective system incorporated into the structure.

Additionally, there is a need to increase sustainability which is the ability to maintain an infrastructure of devices within a building that maintains temperature and comfort level controls in a fine tuned and environmentally efficient fashion. As such if each system is out of tune or not functioning correctly, a goal of building managers is to be able to identify the inefficiency, allow for a system level event to trigger a rapid response team to be able to correct the situation that could be. However presently, if building managers need to adjust the HVAC system they have to go to the HVAC system, if they need to address the electrical system they have to go to electrical management system. If the manager needs to address a security issue they need to go to a separate security management system, and so on as a result there is inherit inefficiency in the building and the control systems.

If there is a system failure, identification, analysis and triggering a response solution has been inefficient due to the requirement for multiple system review. Most building managers have multiple teams “on call” in the event of system failure. For example, if there is HVAC failure, where the HVAC is networked into a building IP network, in order to identify and solve an issue the building manager may be forced to contact both IT and HVAC systems personnel. Typically, this issue is handled by another team and most likely an externalized resource. If the separate team does not understand the requirements of the technology at issue there can be a conflict that needs resolution by an authorized leader of the complete system.

This multi-faceted system design has resulted from a lack of unified planning in the building industry cause by an absence of suitable joint access, monitoring and diagnostic solution as proposed by the present invention.

### State of the Current Art

There are several current systems in the market however none of solve the entire problem identified herein. One such system is known as Java Application Control Engine or JACE. A JACE systems typically include some level of a processor installed in a network which allows for communication protocols such as backnet, lon, or modbus. These communications protocols are traditionally for security, fire, and heating and ventilation systems (HVAC). Certain lighting controls fall under the category of communication, traditionally either lon or backnet. The JACE system allows for control of these systems.

However, for most installations, it is historically cost prohibitive to allow for any kind of analytics trending or forward-thinking proactive approaches related to the data aggregated from the various building systems. This is because each individual building system is siloed, meaning it each system works on its own, with its own database or connection to an offsite third-party control room. When diagnostics are required, for example with an HVAC system, the control room operator typically refers to the HVAC system interface. The same process occurs for security, lighting, fire controls, etc. The JACE system has attempted to aggregate building systems to create fluidity amongst these systems the typical goal is more simplified user control, not data analysis for maximizing efficiency.

In addition, modern building systems output a large amount of data and sometimes the excessive amount of data can result data collisions on the servicing network causing information technology systems lag, and in some cases, complete failure. For instance, if two computers are on the same IP address one system may not progress through the protocols and potentially both systems are going to fail. If constant maintenance is not provided specified integration of service technicians is likely required such as facilities teams, IT teams, and segmented systems team. In this context there is a high likelihood of inefficiency because different technicians will be required to diagnose and solve the problem.

Furthermore, one the drawbacks of the JACE is that they are very complex to set up. A specialist technician requiring expensive training. There are multiple tier levels of training based on how deep a client desires to go into configuration. As such is a client desires to configure a system for trending and analytics there is an expensive licensing and technical resources due to higher level of complexity in the system

### Objects of the Invention

It is an object of the present inventio to provide software application that communicates with machines and systems within a building or residence that allows for quality of life through technology, systems including networks, lighting controls, shades, HVAC, security and communications technologies.

It is also an object of the present inventio to provide software application that communicates with such systems in a single location control room or a remote access site.

It is also an object of the present inventio to provide software application that communicates with such systems in order to provide diagnostics information and sustainability information.

It is also an object of the present inventio to provide a solution to identify which systems team should be contacted to trouble shoot and why they should trouble shoot based on system level information.

### SUMMARY OF THE INVENTION

The present invention includes a system and method for building systems management, diagnostics, troubleshooting and problems solving that aggregates, dynamically analyzes and displays building system information in a user friendly, less technical, fluid, prescribed navigation structure to allows building personnel to control and understand the status of building systems and dynamically manage such building systems and direct resources accordingly.

In a first embodiment, the present invention includes a method including receiving, by one or more processors of a computer system, registration information by a plurality of building system elements, the registration information including a device identifier, a connection identifier, and a password, wherein the device identifier, the connection identifier and the password are each associated with a secure connection of each building system element; verifying, by the one or more processors of the computer system, that the secure connections of each of the plurality of building system element are acceptable; providing, by the one or more processors of the computer system, an interface to a receiving building system element, the interface configured to allow a user to view each of respective secure connection to the building system element and make a selection; providing, by the one or more processors of the computer system connected to a diagnostics session database, diagnostic information of each respective building system element; providing, by the one or more processors of the computer system connected to a diagnostics analytics database, analytics information of each respective building system element; wherein the computer system allows for monitoring and searching of individual building systems elements to help identify, diagnose, troubleshoot and solve building system failures.

In a second embodiment having a computer system, including one or more processors; one or more memory devices coupled to the one or more processors; and one or more computer readable storage devices coupled to the one or more processors, wherein the one or more storage devices contain program code executable by the one or more processors via the one or more memory devices to implement a method, the method including receiving, by one or more processors of a computer system, registration information by a plurality of building system elements, the registration information including a device identifier, a connection identifier, and a password, wherein the device identifier, the connection identifier and the password are each associated with a secure connection of each building system element; verifying, by the one or more processors of the computer system, that the secure connections of each of the plurality of building system element are acceptable; providing, by the one or more processors of the computer system, an interface to a receiving building system element, the interface configured to allow a user to view each of respective secure connection to the building system element and make a selection; providing, by the one or more processors of the computer system connected to a diagnostics session database, diagnostic information of each respective building system element; providing, by the one or more processors of the computer system connected to a diagnostics analytics database, analytics information of each respective building system element; wherein the computer system allows for monitoring and searching of individual building systems elements to help identify, diagnose, troubleshoot and solve building system failures.

In a third embodiment a computer program product, including a computer readable hardware storage device storing a computer readable program code, the computer readable program code comprising an algorithm that when executed by a computer processor of a computing system implements a method including receiving, by one or more processors of a computer system, registration information by a plurality of building system elements, the registration information including a device identifier, a connection identifier, and a password, wherein the device identifier, the connection identifier and the password are each associated with a secure connection of each building system element; verifying, by the one or more processors of the computer system, that the secure connections of each of the plurality of building system element are acceptable; providing, by the one or more processors of the computer system, an interface to a receiving building system element, the interface configured to allow a user to view each of respective secure connection to the building system element and make a selection; providing, by the one or more processors of the computer system connected to a diagnostics session database, diagnostic information of each respective building system element; providing, by the one or more processors of the computer system connected to a diagnostics analytics database, analytics information of each respective building system element; wherein the computer system allows for monitoring and searching of individual building systems elements to help identify, diagnose, troubleshoot and solve building system failures.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows an exemplary database and server connection according to one embodiment of the present invention.

FIG. 2 shows an exemplary data flow diagram for the system according to one embodiment of the present invention.

FIGS. 3 and 4 show dataflow diagrams according to one embodiment of the present invention.

FIG. 5 shows an exemplary framework structure according to one embodiment of the present invention.

FIG. 6 shows an exemplary installation process step flow diagram according to one embodiment of the present invention.

FIG. 7 shows an exemplary flow diagram detailing instance management according to one embodiment of the present invention.

FIG. 8 shows an exemplary data flow for instances according to on embodiment of the present invention.

FIG. 9 shows a detailed example of data flow according to one embodiment of the present invention.

FIG. 10 shows another flow diagram of the system according one embodiment of the present invention.

FIG. 11 shows another dataflow diagram according to another embodiment of the present invention.

FIG. 12 shows an exemplary computing environment according one embodiment of the present invention.

FIGS. 13 through 16 show a series of screens for from the graphical user interface displays for the application according to one embodiment of the present invention.

FIG. 17A shows an exemplary dashboard for the system described herein according to one embodiment of the present invention.

FIG. 17B shows an exemplary dashboard charting result for the system described herein according to one embodiment of the present invention.

FIG. 17C shows an exemplary dashboard network device status for the system described herein according to one embodiment of the present invention.

### DETAILED DESCRIPTION OF THE PREFERRED EMBODIMENTS

The present disclosure will now be described more fully with reference the to the Figures in which an embodiment of the present disclosure is shown. The subject matter of this disclosure may, however, be embodied in many different forms and should not be construed as being limited to the embodiments set forth herein.

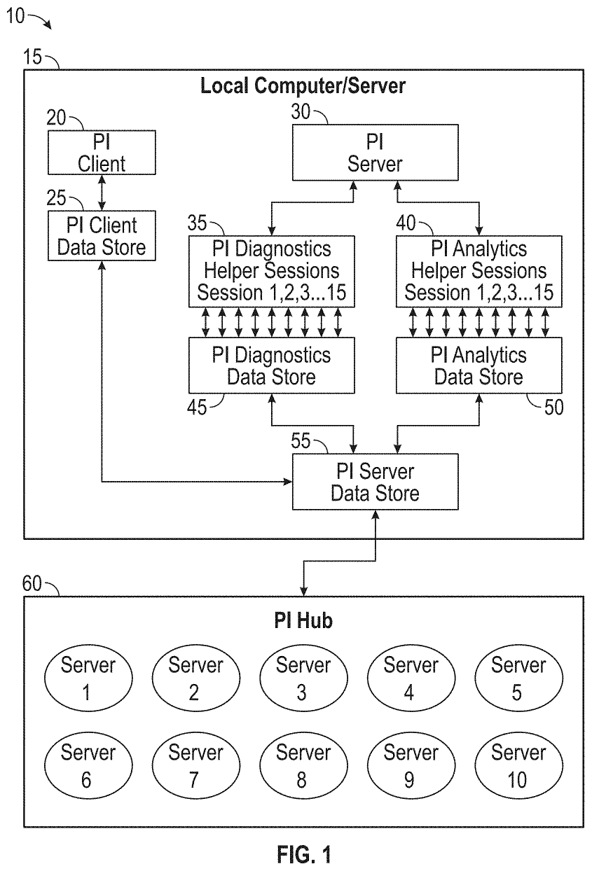

Referring now to FIG. 1 there is shown an exemplary database and server connection according to one embodiment of the present invention. Invention 10 includes a local computer/server 15 housing a local computer or server 15 having a client figure point 20 which can be a graphical user interface and is connected to a client data store 25. The client data store 25 can be in a JACE-on format that is assembled based on the PI server data store 55, which is in a database from which can be sequel light version 3.0. Server data store 55 can also be a sequel express or a comprehensive sequel on server storage based on scaling. This is not limited to SQLExpress or SQL. The Data Store can also be a MySQL or a NoSQL DB such as RavenDB, Mongo, FireBase, ETC.

Server 30 is connected to two different sessions including a diagnostics session 35 and an analytics session 40. Diagnostics session 35 can be a helper session that turns around and allows for multiple sessions in multiple streams to be able to diagnose certain instances within the PI environment. Analytics session 40 has that similar characteristics to the diagnostics session in that it is a helper session, and they both have multiple streams back to the data stores 45 and 50. Diagnostics data stores 45 and analytics data store 50 connect with server data store 55. All of the data and information is routed to hub 60, which can be an aggregate of multiple servers.

The diagnostics session helper sessions 35 allow for a collection of data through the servers 1 through 10 that gets stored within the two data storage on data stores 45 and 50, and then they also are connected back out to the server data store 55, which is connected to the client data store 25. This configuration allows for a view into what our analytics and diagnostics information are.

There are instance connections, which would be under server 30 which can be connected to the diagnostics sessions 35 and analytics helper sessions 40 through just regular socket connection. This configuration allows for a transfer of data whether or not such data stream or information is routed from the different building systems to the diagnostics and analytics helper sessions for storing of data.

In diagnostics sessions 35 and analytics sessions 40 the number of sessions for each respective session is a variable amount based off of how many cores are held on the computer. Typically, these can be spread evenly over those cores, so if by way of example, there are 4 cores, there would be 2 for diagnostics and 2 for analytics and so on and so forth.

As a computer processor has a core, there can be light weight processors that are single core, two core, and servers that go up to 20 cores. As such each core can be a plain core to leverage, and where each core has multiple threads, the data can be written on one thread of each core. For a quad core processor there can be four different helper sessions on diagnostics and/or analytics.

In this location the user interface provides the user a login environment. The user can be a registered account on the server which allows for authentication based on a whitelisting of an IP address. As such in order to get into the system a user must be on an authenticated IP recognized as a direction. Once an authorized user is tied to an account access to a dashboard in granted into a client dashboard. The client dashboard can show multiple rooms as tiles on the user interface which are aggregated the UI will display information showing whether or not a light is on a light is off, for example, in a core lighting system.

The system according to the present invention allows for searchability of individual elements located within a building. Dialog boxes within a graphical user interface detail a location of all elements in the building and can be searched based upon element type, location, age, and status for example whether there is an active live connection to another system element such a processor or database. Embedded in the GUI can be a touch screen with software designed to refresh data periodically and it either go online/offline as well as provide logs of access both electronic logs and physical logs for access to the element at issue with time stamps and personnel data.

The GUI can also provide graphical data in the form charts, Venn diagrams and data bubbles, and the like as a complete aggregation and storyboards type view. A diagnostics screen can live stream data that is being captured and displayed by the system to provide real time data changes for the building systems.

The GUI also includes a slider that allows a user to check various time stamped points status along with a with a visual verification combined with that system data to determine whether the building systems are functioning properly. If there is an absence of streamed data and limited access to a particular element, and the system simulates the data until the element is rebooted to the system and data differences are accounted for in the data stores.

When connecting to a system there is an API connected to the various building elements that provides us general system information. Based on the way that API is configured the system determines which element device is respective to a specific expected response. That response includes data such the exact level, name, and the respective information inherent to the element and subsystem typically over a Telnet stream. The system is therefore actively “listening” to all of the elements internal to the building to determine activity, changes in status and then provide a designed response to any such changes such as ordering parts, deploying a support team and sending reports to team members.

Typical building sub-systems include an intelligent module built in that allows for the system according to the present invention to communicate and transfer data.

Because there are multiple systems and support teams in any single building location, the there may be a standard team member that actually changes the broken element. That person may change the element, for example, but the lamp itself typically does not provide the status information needed to diagnose the system, however, the controls devices such as relays. The present system allows for the single team member to determine the element failure, obtain the correct replacement part and issue maintenance orders and status updates to all team members. This prevents duplicative efforts, increases efficiency in building maintenance and saves costs.

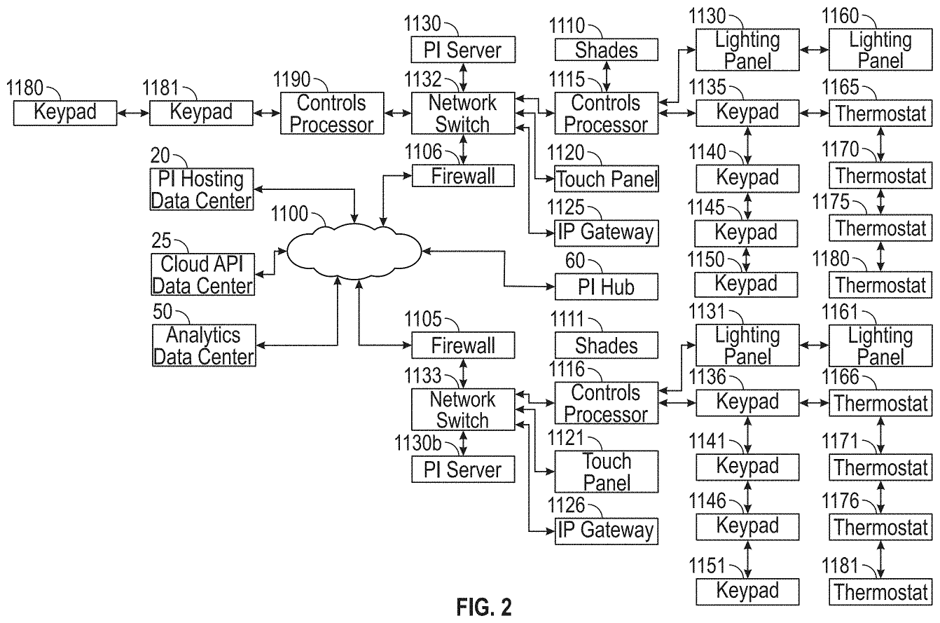

Referring now to FIG. 2, there is shown an exemplary data flow diagram for the system according to one embodiment of the present invention. The present invention can be manifested and/or incorporated into a hub 60 connected to the various elements describe here via cloud 1100. It shall be considered a connection to each of the various elements and to the present invention as long as the elements described herein can be electronically connected via hard line or wireless connection. Included in the architecture of the invention 10 there is a hosting 20, a cloud API data center 25 and an analytics data center 50. The exemplary system described herein relative to FIG. 2 shows two separate and distinct building sub-systems connected to hub 60 via cloud connection 1100. A typically building system can include keypads, 1180, 1181, 1135, 1136, 1140, 1141, 1145, 1146, and 1150, 1151 which can be connected to controls process or 1190, 1116 respectively. Networks switches 1132, 1133 are central to each respective sub-system providing a gateway between hub 60 via firewalls 105, 1106. Each sub-system can further include its own PI server 1130, 1130b to monitor and capture data from the respective sub-system.

There is also included IP gateway addresses 1125, 1127 with touch panels 1115, 1116 connecting through switches 1132, 1133. There is also shades sub-systems 1110, 1111 along with lighting panels 1130, 1131, 1160, and 1162, thermostats 1165, 1166, 1170, 1171, 1175, 1176, 1180 and 1181. It shall be assumed that hub 60 can be connected to an unlimited amount of sub-systems with an unlimited number of elements respectively therein depending upon dataspace and network bandwidth.

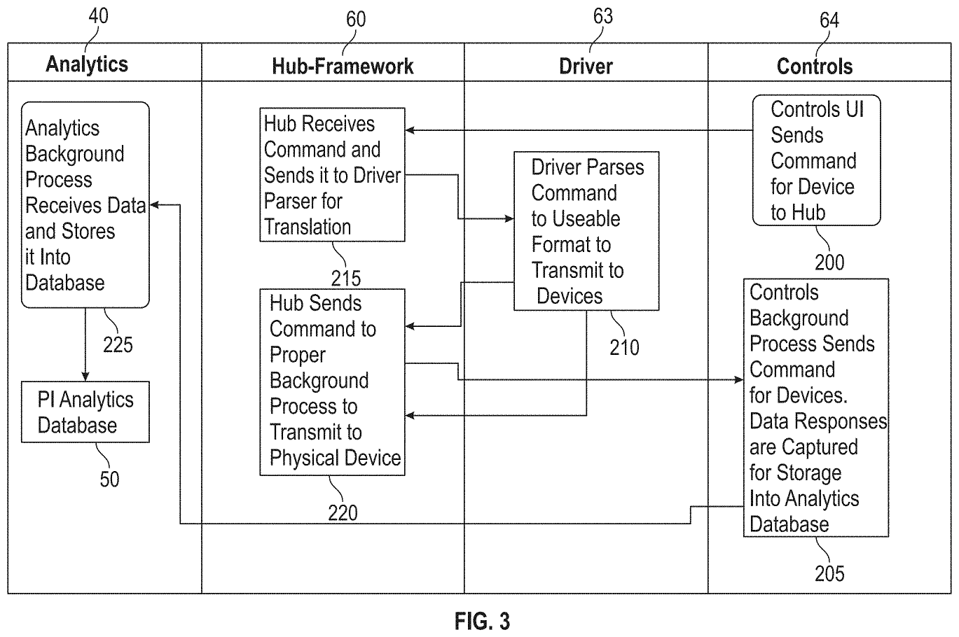

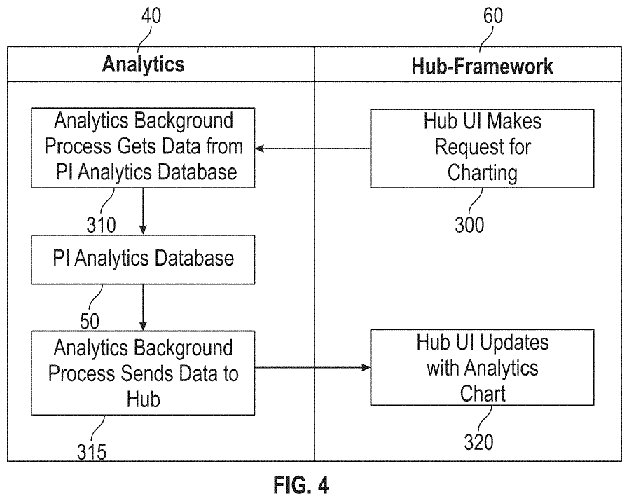

Referring now FIGS. 3 and 4 there is shown dataflow diagrams according to one embodiment of the present invention. Hub framework 60 received a command 200 from controls platform 64. Hub 60 in process 215 sends a signal to driver platform 63 to parse the command into useable format to transmit to devices (step 210). Hub 60 then send commands to proper background process to transmit to physical device (step 220) where controls platform 64 forwards commands to individual devices via step 205. Analytics platform 40 received signal from controls platform 64 and processes the signal as dta and stores it (step 225) into the analytics data base 50.

Referring to FIG. 4 hub framework 60 includes a request by the hub UI for charting step 300 made to analytics 40, where analytics background process step 310 to obtain data from the analytics database 50. Process step 315 sends data back to hub 60 and hub UI updates with analytics data in charts in process step 320.

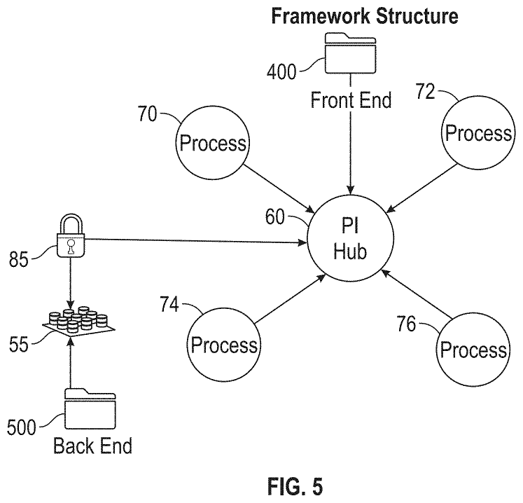

Referring now to FIG. 5 there is shown an exemplary framework structure according to one embodiment of the present invention. Front end system 400 is connected to hub 60 which includes multiple process steps 70, 72, 74, and 76. Backend systems 500 is connected through data store 55 and security system 85 in order to provide a barrier for security of the system.

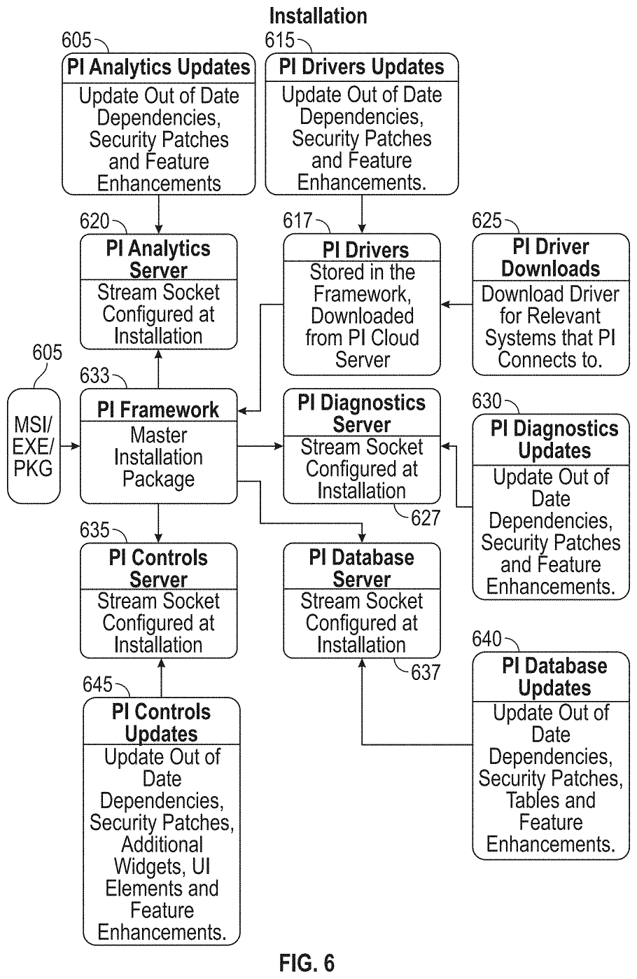

Referring now to FIG. 6 there is shown an exemplary installation process step flow diagram according to one embodiment of the present invention. MSI and EXE packages are used for Microsoft Windows Installations, where PKG is used for Apple or OSX type installations. In the current embodiment MSI/EXE/PKG 605 is connected to framework 633 which is a master installation package. Framework 633 reverts to analytics server 620 where a stream socket is configured and also a controls server 635 where a stream socket is also configured. For server 620 there are analytics updates 605 that include updates to out of date dependencies, security patches and feature enhancements. For server 635 there are control updates 645 which includes updates for out-of-date dependencies, security patches additional widgets, UI elements and feature enhancements.

Framework 633 also includes a connection to Drivers 617 which can be stored in the framework, downloaded from a cloud sever and also includes driver updates 615 and downloads 625. Downloads 625 can include drivers for relevant systems that the system according to the present invention 10 connects with and to.

Framework 633 also connects too diagnostics server 627 where a stream socket is configured with updates 630 as well. There is also a database server 637 connected to framework 633 which also includes a stream socket configuration as well as updated 640.

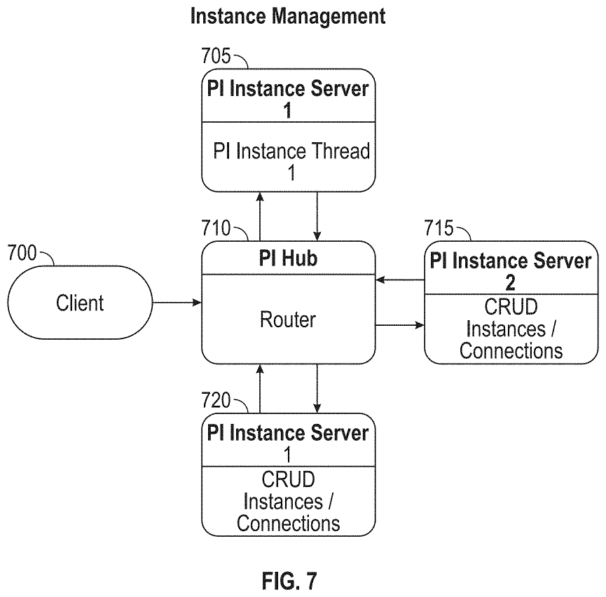

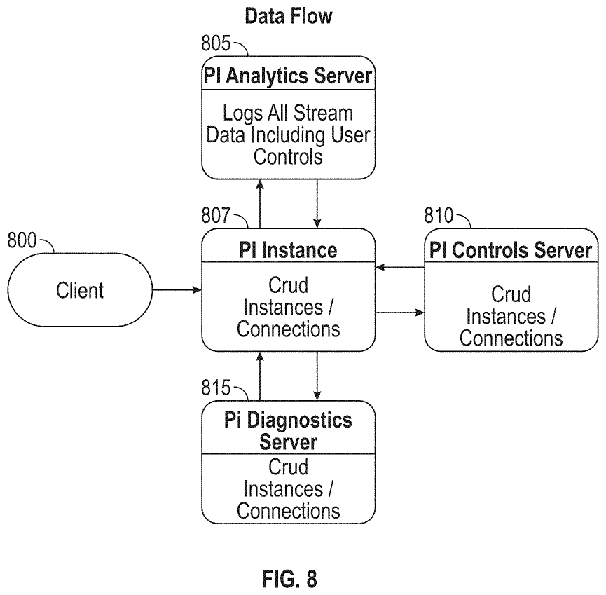

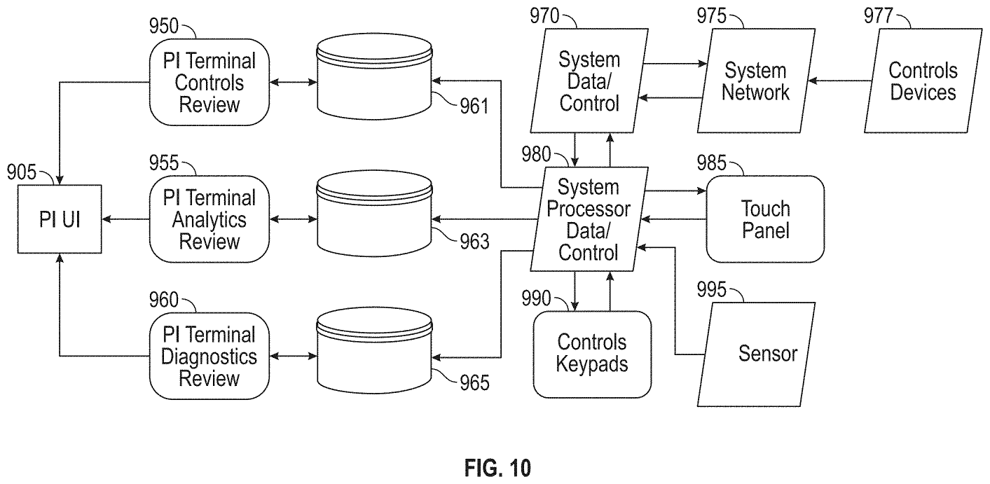

Referring now to FIG. 7 there is shown an exemplary flow diagram detailing instance management according to one embodiment of the present invention. GIG. 7 represents a way that a multi-server deployment would connect to the PI HUB. Each server instance can include from FIG. 6: 635, 645, 637, 627 and 617. FIG. 2: all figures. FIG. 4: 60, 300 and 320. Reference Data Flow from FIG. 10. FIG. 8. Client connection brings the data forward to be a usable connection between the servers. Client 700 can connected to hub/router 710 where instance server 1 (705) includes instance thread 1. Instance server 2 (715) is also connected to hub 710 where CRUD instance/connections. Server 720 includes instance and server with CRUD instances/connections.

Referring now to FIG. 8 there is shown an exemplary data flow for instances according to one embodiment of the present invention. In this example client 800 is connected to instance server 807 housing CRUD instances/connections saved from an analytics server 805 that logs all stream data including user controls. Also connected to server 8070 is a controls server 810 and diagnostics server 815 each with their own CRUD instances/connections therein.

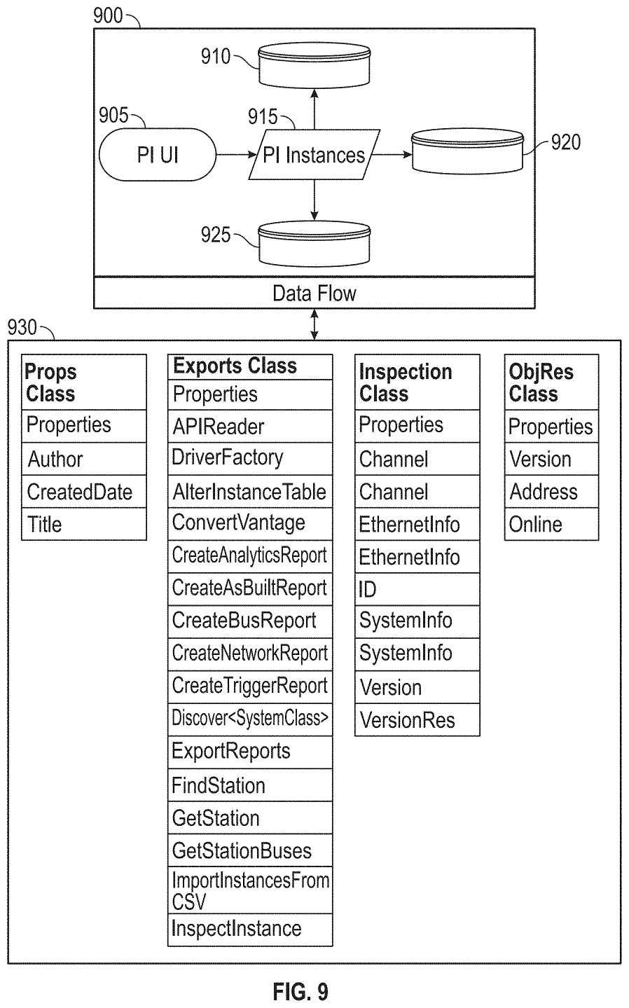

Referring now to FIG. 9 there is shown a detailed example of data flow according to one embodiment of the present invention. Exemplary system 900 includes a user interface 905 having instance 915 connected to various databases 910, 920, 925. Data 930 lists the exemplary data points obtained via instance 915. FIG. 9 discloses driver specific references as an example connection discussen herein

Referring now to FIG. 10 there shown another flow diagram of the system according one embodiment of the present invention. UI 905 is connected to various terminals 950, 955 and 960 backed up with databases 961, 963 and 965 respectively. System processor data/control 980 intakes data from multiple sources and distributes the data to databases 961, 963 and 965 accordingly. Control 980 receives data from control 970 including system network data 975 and control device information 977. Touch panel 985 also provides data to control 980 along with keypads 990 and sensor 995.

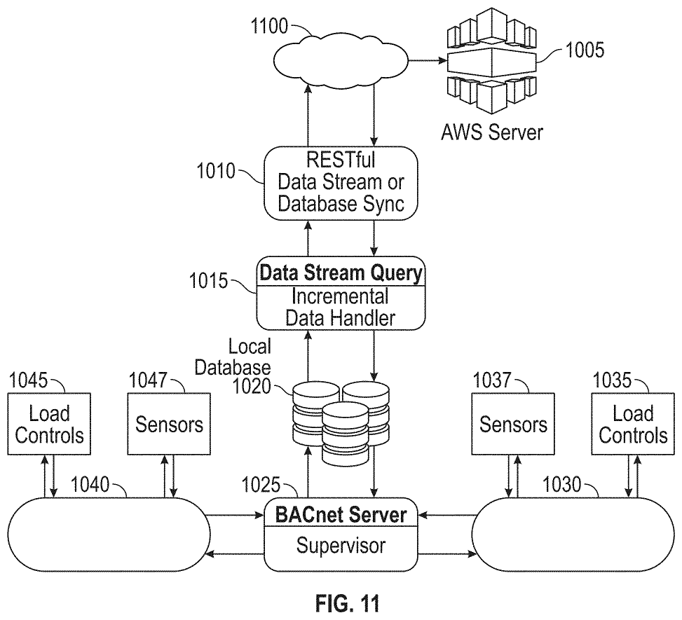

Referring now to FIG. 11 there is another dataflow diagram according to another embodiment of the present invention. Data stream query 1015 includes an incremental data handler connected to a RESTful data stream/database sync and an AWS type server 1005 via cloud 1100. Local databases 1020 are between query 1015 and BACnet server 1025 which acts as a supervisor for databases 1030, 1040 which collect data from sensors 1037, 1047 and load controls 1035, 1045 accordingly.

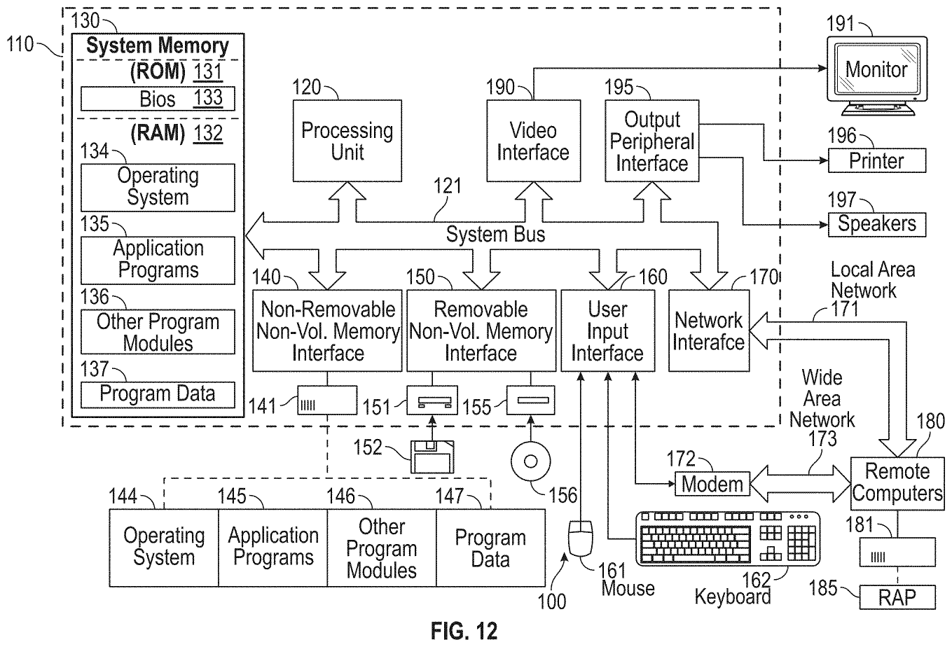

Referring now to FIG. 12 which shows a computing environment in which algorithms as described in reference to FIGS. 1-11 have been developed and maintained. Communication protocols on the server-side may reside on and may be executed by server level computers, which may be in communication with each of the elements listed in this specification via network connection (e.g., the Internet or a local area network). Examples of a server computer may include, but are not limited to: a personal computer, a server computer, a series of server computers, a mini computer, and/or a mainframe computer. The server computer may be a distributed system and the operations of server computer may execute on one or more processors, simultaneously and/or serially. For example, a server computer may be a symbolic representation of a cloud computing site, cloud environment, or cloud platform running multiple servers, computers, or virtual machines. A server computer may execute one or more operating systems, examples of which may include but are not limited to. Microsoft Windows Server™; Novell Netware™; Redhat Linux™, Unix, or a custom operating system, for example.

For example, a server computer may be a symbolic representation of a cloud-based automated checkout system, cloud-based package tracking system, or server suitable for performing the operations described in the present disclosure. In an implementation, a server computer may be a cloud-based automated real time updating database system and/or cloud-based data tracking system or server which may include, store, run, and/or execute automated processes and/or software programs or algorithms as described herein. A cloud-based automated system and/or cloud-based data tracking system, or server may be part of a network of servers and other computing devices administered by a company or business that uses automated processes and/or data tracking processes, such as a telecommunications company or database retailer or physical store selling services to customers.

There are instruction sets and subroutines of a server-side automated data process and/or data tracking process, which may be stored on a storage database device coupled to a server computer, which instruction sets and subroutines may be executed by one or more processors and one or more memory architectures incorporated into a server computer or a series of server computers. Storage devices may include but are not limited to: a hard disk drive; a tape drive; an optical drive; a solid state storage device; a RAID array; a random access memory (RAM): and a read-only memory (ROM).

Server computer(s) may execute a web server application that allows for access to the server computer (via a telecommunications or wifi network) using one or more protocols, examples of which may include but are not limited to HTTP (i.e., HyperText Transfer Protocol). Networks may be in communication with one or more secondary networks, examples of which may include but are not limited to: a local area network; a wide area network; or an intranet, for example.

Client-side or user automated data processes and/or client-side or user data tracking processes may reside on and may be executed by client (user) electronic devices, examples of which may include but are not limited to personal computer, a television with one or more processors embedded therein or coupled thereto, a laptop computer, a data-enabled mobile telephone or smartphone, notebook computer, a tablet, and a personal digital assistant, for example. Client electronic devices may each be in communication with a network and may each execute an operating system, examples of which may include but are not limited to Apple iOS™, Microsoft Windows™, Android™, Redhat Linux™, or a custom operating system.

In an implementation, one or more of client electronic devices may be associated with an associate, employee, or customer of the company or business that uses one or more of the automated data process and/or data tracking processes. For example, a data-enabled mobile telephone may be a mobile device such as a smartphone associated with the associate, employee, or customer.

The instruction sets and subroutines of client-side automated data processes and/or client-side data tracking processes may be stored on storage devices coupled to client electronic devices, which instruction sets and subroutines may be executed by one or more processors and one or more memory architectures incorporated into client electronic devices. Storage devices may include but are not limited to: hard disk drives; tape drives; optical drives; solid state storage devices; RAID arrays; random access memories (RAM); read-only memories (ROM); compact flash (CF) storage devices; secure digital (SD) storage devices; and memory stick storage devices.

Client-side automated data processes and/or server-side automated data processes may be processes that run within (i.e., are part of) a cloud computing site, cloud computing application, cloud platform, or cloud environment. Alternatively, client-side automated data processes and/or server-side automated data process may be stand-alone applications that work in conjunction with the cloud computing site, cloud computing application, cloud platform, or cloud environment. One or more of client-side automated data processes and server-side automated data processes may interface with each other (via the telecommunications network or WIFI network). Further, client-side data tracking processes and/or server-side data tracking processes may be processes that run within (i.e., are part of) a cloud computing site, cloud computing application, cloud platform, or cloud environment. Alternatively, client-side data tracking processes and/or server-side data tracking process may be stand-alone applications that work in conjunction with the cloud computing site, cloud computing application, cloud platform, or cloud environment. One or more of client-side data tracking processes and/or server-side data tracking process may interface with each other (via telecommunications networks and/or WIFI network).

Users may access server-side automated data process and/or server-side data tracking processes directly through the device on which the client-side automated data process or client-side data tracking processes are executed, namely client electronic devices, for example. Users may access server-side automated data processes and/or server-side data tracking processes directly through telecommunications networks and/or through secondary networks. Further, a server computer (i.e., the computer that executes server-side automated data process and/or server-side data tracking process) may be in communication with the telecommunications network through a secondary network via a phantom link line.

The various client electronic devices may be directly or indirectly coupled to a telecommunications network or WIFI network. For example, a personal computer can be directly coupled to a telecommunications network via a hardwired network connection. Further, a notebook computer can be coupled to a network via a hardwired network connection. A laptop computer can be wirelessly coupled to a network via wireless communication channel established between laptop computer and wireless access point (i.e., WAP), which WAP coupled to a telecommunications network. A WAP may be, for example, an IEEE 802.11a, 802.11b, 802.11g, 802.11n, Wi-Fi, and/or Bluetooth device that is capable of establishing a wireless communication channel between a laptop computer and the WAP. A data-enabled mobile telephone can be wirelessly coupled to a network via wireless communication channel established between data-enabled mobile telephone and a cellular network/bridge, which can also be directly coupled to telecommunications network.

All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and personal digital assistants to be interconnected using a short-range wireless connection.

With reference to FIG. 12, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information, and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 12 illustrates operating system 134, application programs 135, other program modules 136, and program data 137.

The computer 110 may also include other removable/non-removable, volatile and nonvolatile computer storage media. By way of example only, FIG. 12 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 12, provide storage of computer-readable instructions, data structures, program modules, and other data for the computer 110. In FIG. 12, for example, hard disk drive 141 is illustrated as storing operating system 144, application programs 145, other program modules 146, and program data 147. Note that these components can either be the same as or different from operating system 134, application programs 135, other program modules 136, and program data 137.

Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 12. The logical connections depicted in FIG. 12 include a local area network (LAN) 171 and a wide area network (WAN) 173 but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 12 illustrates remote application programs 185 as residing on memory device 181. It will be appreciated that the network connections shown are exemplary and other means of establishing a communications link between the computers may be used.

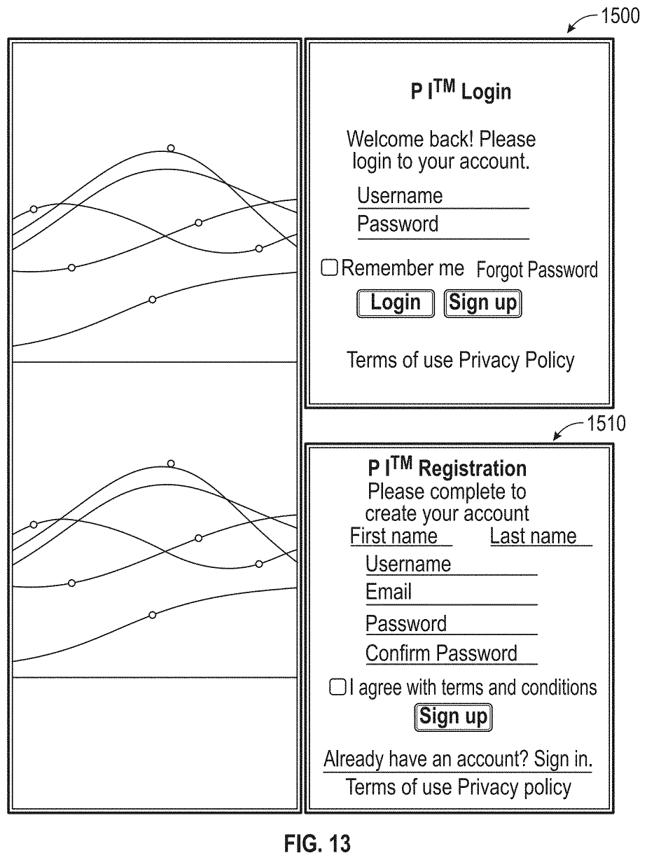

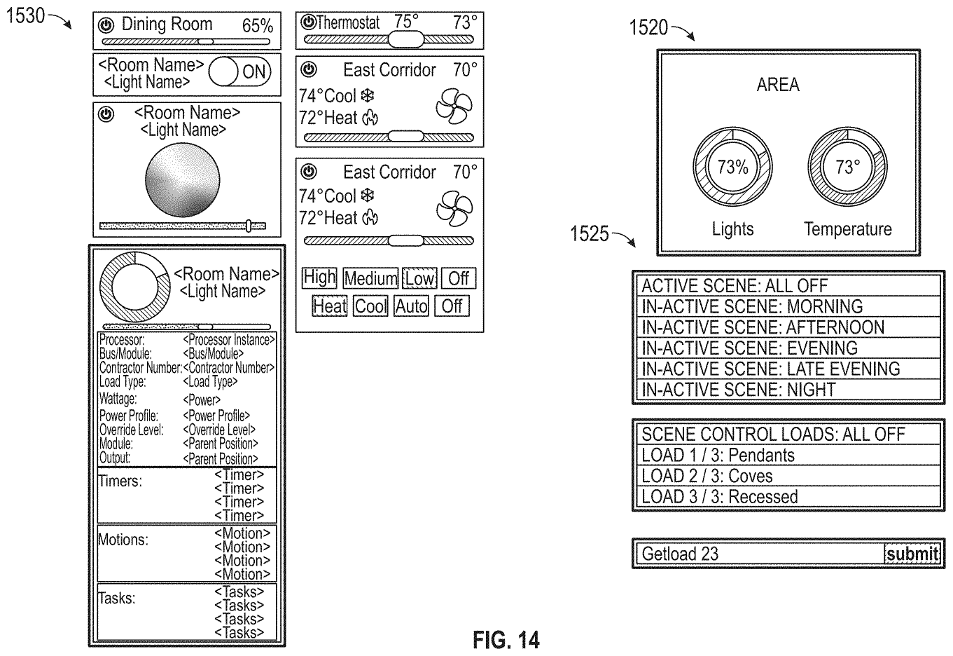

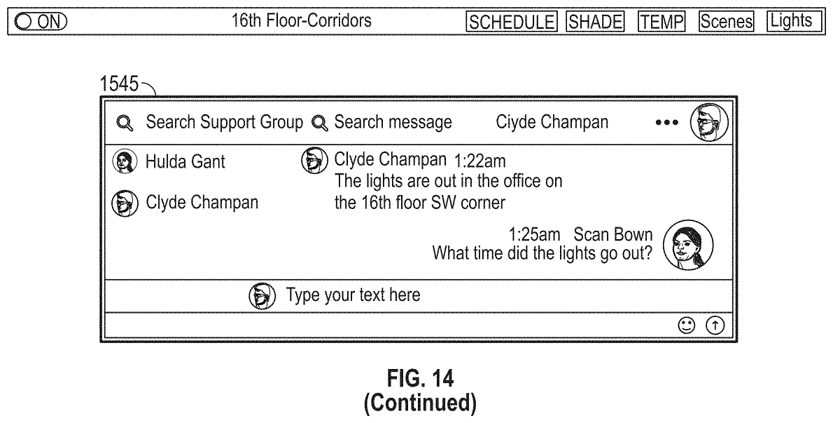

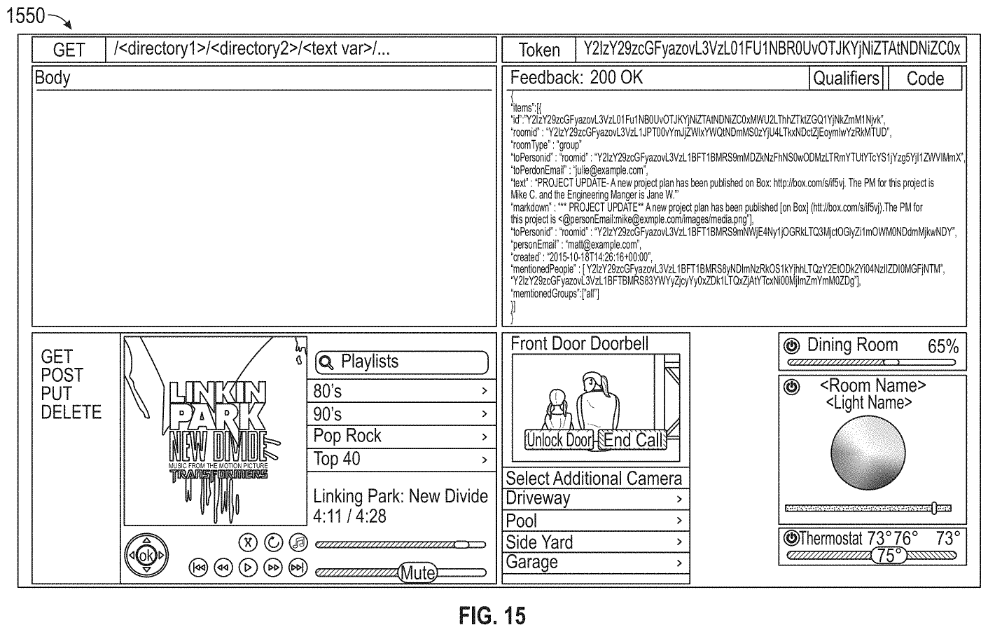

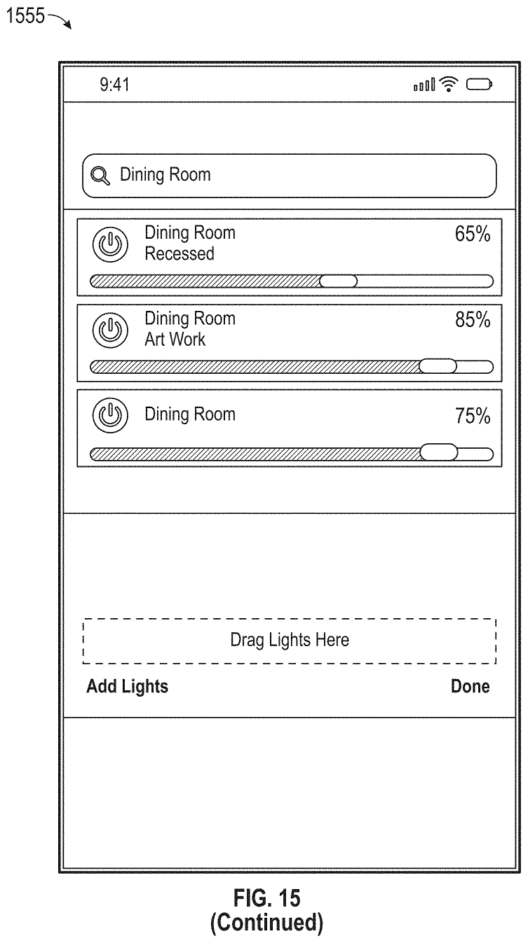

Referring now to FIGS. 13 through 16 there is shown a series of screens for from the graphical user interface displays for the application according to one embodiment of the present invention. User login 1500 provides users with the ability to access the invention 10 and registration input 1510 allows users to register into the system for authorization access. FIG. 15 shows various diagnostic displays to a user via the GUI.

Referring now to FIG. 15 there are various controls provided such as a controls accordion bar including:

Area On/Off Toggle. This will be updated once the area is turned off or goes to an unoccupied state.

Area name for the individual looking at the controls dashboard to be able to see the area that is relevant to the accordion.

Schedule allows for a calendar to appear in the accordion UI. This will allow for the user to enter into the scheduling widget relevant to the area.

Temp allows for the user to toggle into the thermostat widgets relevant to the area.

Scenes allows for the user to toggle into the scene widgets relevant to the area. This would be used for multiple loads, or objects to be controlled by a single button press. This usually corresponds to a button in the area; and lights allows for the user to control each of the lights in the designated area. This allows for individual lighting controls of the lighting zones in the area.

The Lighting Toggle Widget allows for the individual load to be turned on and off without any dimming controls. This is typically used for switched outlets, lamps and motor loads. The Lighting Toggle Widget allows for the individual load to be turned on and off without any dimming controls. This is typically used for switched outlets, lamps and motor loads. The Color Wheel Widget allows for the individual load to be turned on, off, dimmed and color adjustment. This is typically used for any RGB, RGBA, RGBW, RGB+IF, RGBA+IF and RGBW+IF type Lighting load. Thermostat Widget allows for the controls of a thermostat Heating and Cooling Setpoints, mode of operations and fan speed. Mini Thermostat Widget allows for the controls of a thermostat Heating and Cooling Setpoints and sets the mode to auto or off only.

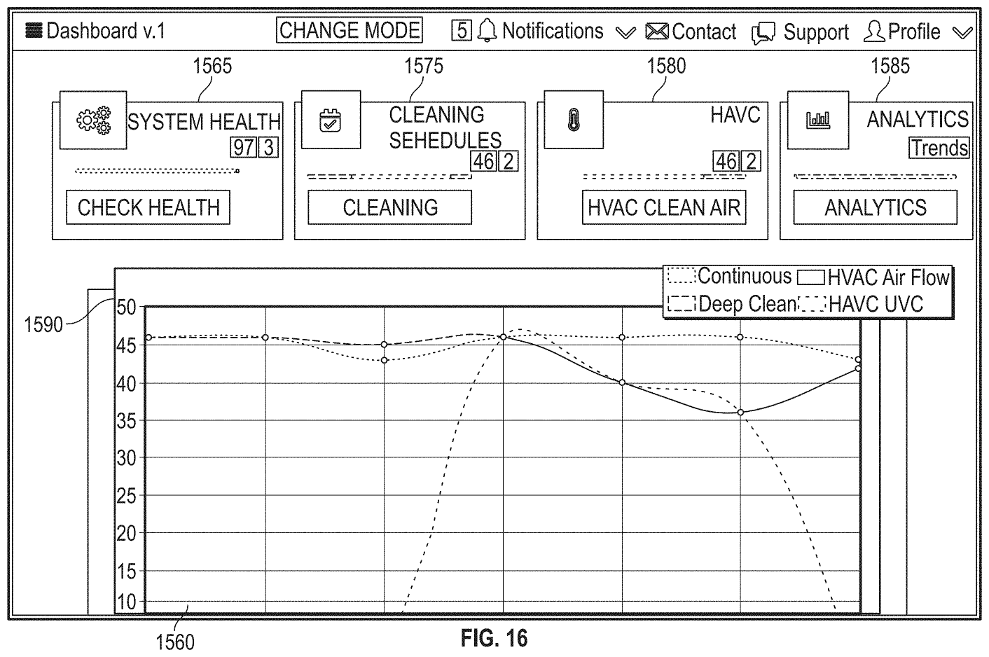

Referring now to FIG. 16 there is shown a screen shot of graphical user interface display showing diagnostics for building cleaning schedules and progress 1560. Diagnostics block 1565 shows an overall system health, while block 1575 shows progress of cleaning schedules, 1580 shows HVAC status and 1585 shows analytic data. Each of these blocks is further accessible from a touch screen in the GUI in order to drill down into additional information. Block 1590 show a graphical interpretation of each of the blocks previously mentioned and provides a user with real time assessment of the cleanliness a building and its systems.

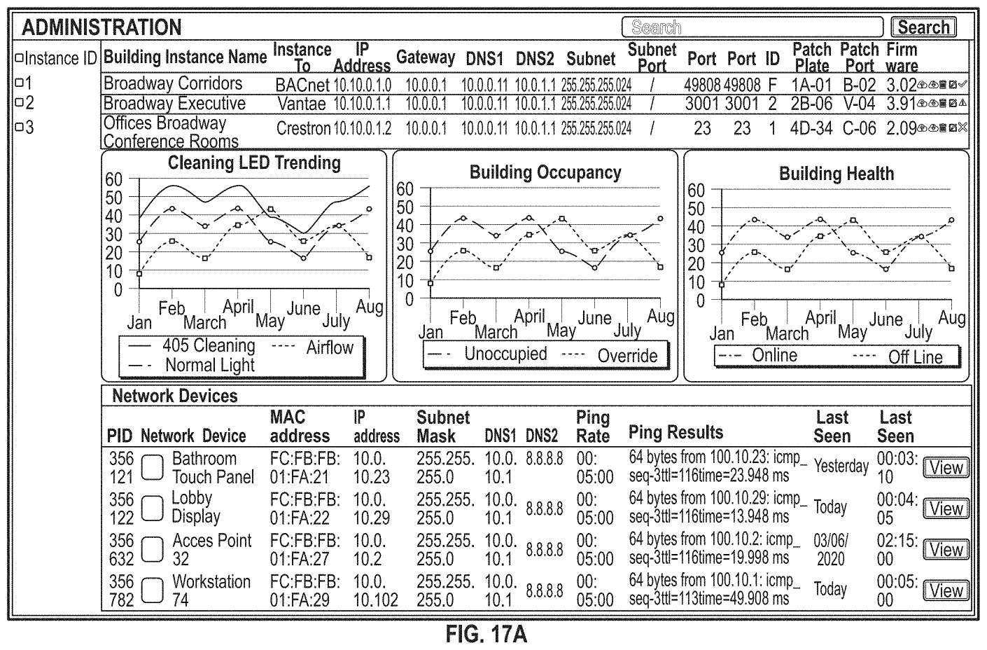

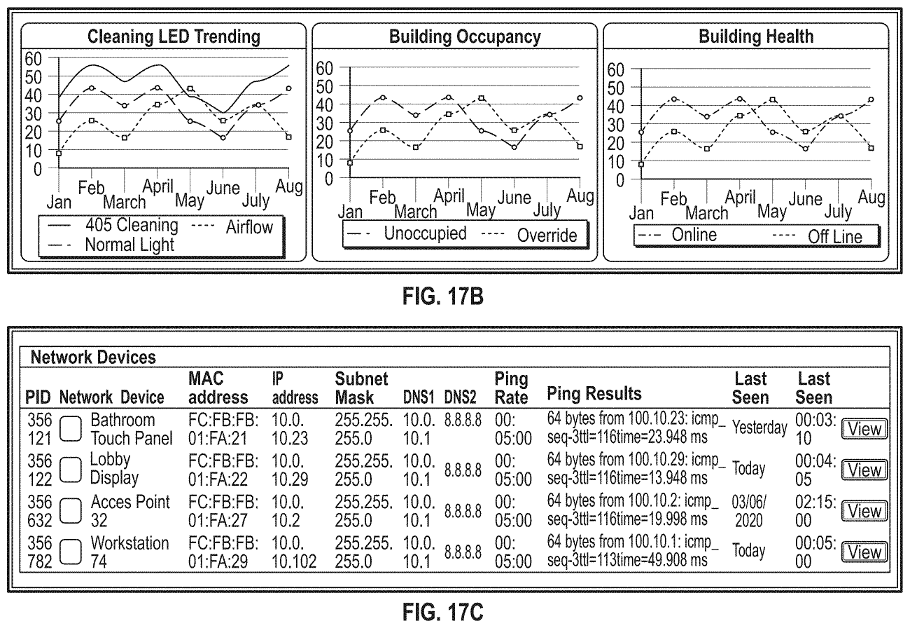

Referring now to FIG. 17A there is shown an exemplary dashboard for the system described herein according to one embodiment of the present invention. The dashboard allows users to know that they are in an administrative screen vs a user screen. This location would read the following states:

Administration: Which is the main admin dashboard

Administration: IT: Which is for IT Users

Administration: Facilities: Which is for facilities Users

Administration: Super: Which is for technicians Users

The Search box is for global search of all system objects within the system:

Objects.

Object types; and

Conditions or flags for issues.

Navigation to features within the system Command Center include:

Email: Adjust email settings used in the system for alerting functionality

Chat: Adjust Chat settings for use with chat bot and chat services integration for alerting and system logs to administrative groups for alerting functionality.

Todo: Allows a checklist for administrator functions as well as system logged troubles that have not been acknowledged.

Calendar: Allows for the admin to set and monitor schedules from

intervals of programs running

Scheduled tasks to be executed for system operations

Timers: Allows for the admin to set and monitor schedules from

Scheduled tasks to be executed for system operations

Lights: Allows the administrator to edit the lighting objects

Thermostats: Allows the administrator to edit the thermostat objects

Video: Allows the administrator to edit the Video objects

CCTV: Allows the administrator to edit the Video Stream objects

Audio: Allows the administrator to edit the Audio objects

Network: Allows the administrator to edit the network objects

The selection boxes allow for you to target only some lines vs all lines to help prevent inadvertent editing of system objects.

Instance ID: is the PI™ instance ID that is assigned to each instance.

Building: Is the name of the building to be used for campus or multi-location facilities.

Instance Name: Is the location or user identifiable location of the processor or server that is being referenced.

Instance Type: is the identification and selection of the relevant PI™ drivers needed to be used or currently being used for the instance. Only 1 driver can be selected for an instance.

IP Address is the connection IP Address that the host resides.

Gateway: is the default gateway that the device is configured on the network

DNS1: is the primary DNS configuration for the device is configured on the network

DNS2: is the secondary DNS configuration for the device is configured on the network

Subnet: is the subnet mask that the device is configured on the network

Subnet: is the subnet mask that the device is configured on the network in a/configuration.

Port: is the TCP/UDP port that is being connected to for communications. This may have a couple of ports required depending on services.

IDF: This is the MDF/IDF location that device is connected to.

Patch Plate: is the patch plate designation from the wall plate that the field termination relevant to the IT patching schedule.

Patch Port: is the patch plate designation from the rack patch panel that the field termination relevant to the IT patching schedule.

Firmware: is the current firmware of the host that the connection has been established to.

Cloud up: this is where you can upload relevant programming or export files for labeling and device schedules for the host. These files are typically relevant to the host programming.

Cloud down: this is where you can discover devices or download from the host relevant programming or export files for labeling and device schedules for the host. These files are typically relevant to the host programming.

Pencil and paper: this is where you make the line that you are on editable for quick edits of the manageable fields.

Trash: allows you to delete the instance.

Check: Lets you know that the host is operating properly.

Triangle: Lets you know that there is some degradation to the system operations.

Triangle: Lets you know that there is complete failure to the system operations.

Referring now to FIG. 17B there is shown an exemplary dashboard charting result for the system described herein according to one embodiment of the present invention. The system includes a charting feature and mechanism that allow the user to customize what system status is relevant by providing various data points as follows:

Cleaning LED Trending: Allows the user to visualize cleaning lights vs normal lights in a space with the ability to show air flow trending over time. This is designed for quick reference and refers to data that will be exported to analytics.

Building Occupancy. Allows the user to identify typical building occupancy over time trending over time. This is designed for quick reference and refers to data that will be exported to analytics.

Building Health: Allows the user to identify typical building health over time trending over time. This is designed for quick reference and refers to data that will be exported to analytics.

Referring now to FIG. 17C there is shown an exemplary dashboard network device status for the system described herein according to one embodiment of the present invention with the following attributes.

PID: is the PI™ instance ID that is assigned to each instance.

Network Device: Shows an icon of the device type and a relevant label for the user to identify the device.

MAC Address is the unique MAC address of the device being monitored.

IP Address is the connection IP Address of the device being monitored.

Gateway: is the default gateway of the device being monitored.

DNS1: is the primary DNS configuration of the device being monitored.

DNS2: is the secondary DNS configuration of the device being monitored.

Ping Rate: This is the frequency that the device will be checked.

Ping Results: Will show the ping results of the last test.

Last Seen: Depicts when the device was last responsive on the network.

It will be apparent to one of skill in the art that described herein is a novel apparatus, system and method for building system diagnostics. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

We claim:

1-3. (canceled)

4. A method comprising the steps of;
receiving, by one or more processors of a computer system, registration information by a plurality of building system elements, the registration information including a device identifier, a connection identifier, and a password, wherein the device identifier, the connection identifier and the password are each associated with a secure connection of each building system element;
verifying, by the one or more processors of the computer system, that the secure connections of each of the plurality of building system element are acceptable;
providing, by the one or more processors of the computer system, an interface to a receiving building system element, the interface configured to allow a user to view each of respective secure connection to the building system element and make a selection;
providing, by the one or more processors of the computer system connected to a diagnostics session database, diagnostic information of each respective building system element;
providing, by the one or more processors of the computer system connected to a diagnostics analytics database, analytics information of each respective building system element;
wherein the computer system allows for monitoring and searching of individual building systems elements to help identify, diagnose, troubleshoot and solve building system failures.

5. The method according to claim 4, where the step of providing diagnostic information of each respective building further comprises the step of connecting to an instance server having a series of instance threads stored thereon.

6. The method according to claim 5, where the step of providing diagnostic information of each respective building further comprises the step of connecting to an analytics server having a log of stream data including ser controls stored thereon.

7. A computer system, comprising:
at least one processor;
at least one memory device coupled to the one or more processors; and
at least one computer readable storage device coupled to the one or more processors,
wherein the one or more storage devices contain program code executable by the lone or more processors via the one or more memory devices to implement a method, the method comprising:
receiving, by one or more processors of a computer system, registration information by a plurality of building system elements, the registration information including a device identifier, a connection identifier, and a password, wherein the device identifier, the connection identifier and the password are each associated with a secure connection of each building system element;
verifying, by the one or more processors of the computer system, that the secure connections of each of the plurality of building system element are acceptable;
providing, by the one or more processors of the computer system, an interface to a receiving building system element, the interface configured to allow a user to view each of respective secure connection to the building system element and make a selection;
providing, by the one or more processors of the computer system connected to a diagnostics session database, diagnostic information of each respective building system element;
providing, by the ONE or more processors of the computer system connected to a diagnostics analytics database, analytics information of each respective building system element;
wherein the computer system allows for monitoring and searching of individual building systems elements to help identify, diagnose, troubleshoot and solve building system failures.

8. A computer system as in claim 7, where the at least one processor is a core processor.

9. A computer system as in claim 7, where the at least one processor is a lightweight processor.

10. A computer system as in claim 7, wherein the computer readable storage devices comprise a hard drive disk, a tape drive, an optical drive, a solid-state storage device, a RAID array, a random-access memory (RAM), and a read-only memory (ROM).

11. A computer system as in claim 7, wherein the computer system further comprises a hosting, a cloud API data center, and an analytics data center.

12. A computer system as in claim 7, wherein the hosting is connected to at least two separate and distinct building sub-systems via cloud connection.

13. A computer program product, comprising a computer readable hardware storage device storing a computer readable program code, the computer readable program code comprising an algorithm that when executed by a computer processor of a computing system implements a method comprising:
receiving, by one or more processors of a computer system, registration information by a plurality of building system elements, the registration information including a device identifier, a connection identifier, and a password, wherein the device identifier, the connection identifier and the password are each associated with a secure connection of each building system element;
verifying, by the one or more processors of the computer system, that the secure connections of each of the plurality of building system element are acceptable;
providing, by the one or more processors of the computer system, an interface to a receiving building system element, the interface configured to allow a user to view each of respective secure connection to the building system element and make a selection;
providing, by the one or more processors of the computer system connected to a diagnostics session database, diagnostic information of each respective building system element;
providing, by the one or more processors of the computer system connected to a diagnostics analytics database, analytics information of each respective building system element;
wherein the computer system allows for monitoring and searching of individual building systems elements to help identify, diagnose, troubleshoot and solve building system failures.

14. A computer product program as in claim 13, wherein the computer system includes volatile and nonvolatile media, and removable and non-removable computer-readable media.

15. A computer product program as in claim 14, wherein the computer-readable media comprises computer storage media and communication media.

16. A computer product according to claim 15, wherein the communication media comprises computer-readable instructions, data structures and program modules.

17. A computer product according to claim 16, wherein the communication media further comprises a modulated data signal.

18. The computer product according to claim 17, wherein the modulated data signal is a carrier wave.

19. The computer product according to claim 17, wherein the modulated data signal is a transport mechanism.

20. The computer product according to claim 17, further comprising an information delivery media.

21. The computer product according to claim 16, wherein the communication media includes a wired media where the wired media is a wired network or direct-wired connection.

22. The computer product according to claim 16, wherein the communication media includes a wireless media selected from the group consisting of acoustic, radio frequency (RF) or infrared.
